(19) United States
(12) Patent Application Publication
(10) Pub. No.: US 2012/0301588 A1
(43) Pub. Date: Nov. 29, 2012

(54) HIGH FIBER CHEWABLE COMPOSITIONS AND METHODS OF MAKING

(75) Inventor: Mary A. Watson, Valparaiso, IN (US)

(73) Assignee: CARGILL INCORPORATED, Wayzata, MN (US)

(21) Appl. No.: 13/482,200

(22) Filed: May 29, 2012

Related U.S. Application Data
(60) Provisional application No. 61/490,158, filed on May 26, 2011.

(51) Int. Cl. A23G 3/42; A23L 1/236

(52) U.S. Cl. 426/548; 426/658

(57) ABSTRACT

The present disclosure describes chewable compositions comprising liquid inulin, a gelling agent, and water. The chewable compositions include at least 60% liquid inulin. Also described are methods for producing a chewable composition. The methods include providing liquid inulin, combining the liquid inulin with a gelling agent solution to yield a liquid inulin gelling agent mixture, depositing the liquid inulin gelling agent mixture into a mould, allowing the liquid inulin gelling agent mixture in the mould to set to yield a liquid inulin chewable composition, and removing the liquid inulin chewable composition from the mould.

### CROSS REFERENCE TO RELATED APPLICATION

This application claims the benefit of U.S. Patent Application Ser. No. 61/490,158, filed on May 26, 2011, entitled “HIGH FIBER CHEWABLE COMPOSITIONS AND METHODS OF MAKING,” which is incorporated herein by reference.

### FIELD OF THE INVENTION

The present disclosure relates to a chewable composition comprising liquid inulin, a gelling agent and water. The liquid inulin makes up at least 60% by weight of the chewable composition. The present disclosure also relates to the method of producing such a chewable composition.

### BACKGROUND OF THE INVENTION

Fiber is an important part of the diet of humans. The average person in the United States does not consume enough fiber on a daily basis. While fiber intake can be increased by eating foods high in fiber, many consumers are unwilling to cat large amounts of high fiber foods, and thus look to supplements to provide the additional needed fiber. To date there are several types of fiber supplements available including powders, tablets, beverages etc., with varying degrees of consumer acceptance.

Attempts have been made to formulate fiber into palatable, easily ingestible confectionary articles, such as soft chews. Often such chews include various polyols or other carbohydrates to provide good texture and mouthfeel to the chew. Such additions may reduce the amount of fiber in the chew and may provide ingredients which certain consumers do not wish to have incorporated into their chew. Thus, the need exists for a chew with few ingredients on a label, high amounts of fiber, and good texture and mouthfeel; as well as methods of making such a chew.

### SUMMARY OF THE INVENTION

One aspect of the present invention features a chewable composition that includes liquid inulin, a gelling agent, and water. The liquid inulin makes up at least 60% by weight of the chewable composition.

Another aspect of the present invention features a method for producing a chewable composition. The method includes providing liquid inulin, combining the liquid inulin with a gelling agent solution to yield a liquid inulin gelling agent mixture, depositing the liquid inulin gelling agent mixture into a mould, allowing the liquid inulin gelling agent mixture in the mould to set to yield a liquid inulin chewable composition, and removing the liquid inulin chewable composition from the mould.

It has been surprisingly discovered that chewable compositions including high concentrations of inulin were successfully produced utilizing liquid inulin, but attempts to make such compositions with powdered inulin were unsuccessful. When a powdered inulin was utilized, such high concentration inulin chewable compositions were difficult to produce, and the chew made from powdered inulin did not have as pleasant a mouthfeel or texture as the chews produced using liquid inulin.

In addition, methods of producing such chewable compositions using liquid inulin require a significantly shorter setting time than methods for producing comparable chewable compositions not including liquid inulin.

### DETAILED DESCRIPTION OF THE INVENTION

The chewable compositions described herein include liquid inulin, a gelling agent, and water. The liquid inulin comprises at least 60% by weight of the chewable composition. The chewable compositions can also include other ingredients such as colorings, sweeteners, or flavorings.

The term “chewable composition”, as used herein, means a composition which is meant to be chewed by and consumed by a human. The chewable composition does not mean those compositions commonly called “chewing gums” which are meant to be chewed by a human and subsequently discarded rather than consumed. The chewable compositions of the present invention are those which are commonly referred to as jelly, gummy, or gummi candies.

The chewable composition of the present invention could be considered a food product or a pharmaceutical product.

Inulin is a linear oligomer comprising β-D-fructose units linked to a terminal α-D-glucose unit. The fructose units are linked by a β(2→1) bond. The amount of fructose units in an inulin molecule can vary widely, for example from 2 units to several thousand units. Compounds with smaller amounts of fructose units are called fructooligosaccharides, the simplest being 1-ketose, which has 2 fructose units and 1 glucose unit. An inulin molecule can be represented by the following diagram:

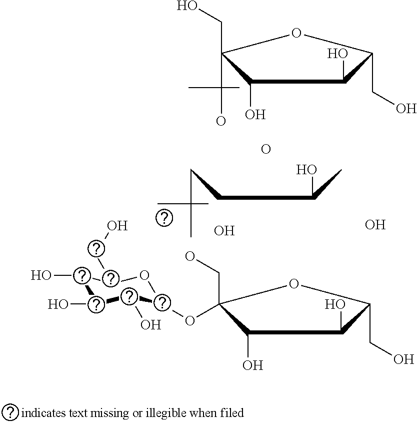

The term “liquid inulin”, as used herein, means inulin extracted from a plant source (for e.g. chicory root) which has not undergone a drying stage (such as spray drying) to remove water from the inulin extract. An exemplary liquid inulin product is Fibrulose® L85 Inulin commercially available from Cosucra Groupe Warcoing.

Inulin is conventionally extracted from plants, such as chicory root, using a water extraction. The production of inulin generally includes several other stages such as purification, demineralization, concentration, etc. Often, it can also be desirable to control for degree of polymerization of the inulin chains. To produce a powdered inulin, a drying stage is utilized to remove water from the inulin extract. After water removal, the dry inulin is typically granulated to produce a powdered inulin.

Thus, liquid inulin can be contrasted with powdered inulin in that powdered inulins are those have been subjected to a drying stage (such as spray drying) which removes substantially all the water from the inulin extract. Liquid inulin has not had substantially all water removed after being extracted from the plant. As such, liquid inulins have a lower dry matter content than powdered inulins. For example, Fibrulose® L85 Inulin has a dry solids content of 74%-76% dry matter. Powdered inulins typically have a dry matter content of greater than or equal to 95%.

As a vehicle for fiber incorporation in many types of compositions, powdered inulins work satisfactorily. However, powdered inulin does not work as well as liquid inulin for incorporation into chewable compositions. It has been surprisingly discovered, that after water removal from the inulin extract using a spray drying process (or other drying process), the powdered inulin is not as effective in producing gummy or jelly type chewable compositions. The production of gummy or jelly type chewable compositions with satisfactory texture and mouthfeel with a very high concentration of inulin is only possible utilizing liquid inulin. As seen in the accompanying examples, attempts were made to use powdered inulin by dissolving it at high temperatures in water. For a number of reasons, such processes were unsuccessful. Thus, the utilization of liquid inulin was successful, but utilization of powdered inulin dissolved in a solvent was not successful to produce the desired high fiber inulin chewable compositions.

In some embodiments, the liquid inulin comprises at least 60% by weight of the chewable composition. In other embodiments, the liquid inulin comprises at least 65% by weight of the chewable composition. In yet other embodiments, the liquid inulin comprises at least 70% by weight of the chewable composition. In yet other embodiments, the liquid inulin comprises at least 75% by weight of the chewable composition. In yet other embodiments, the liquid inulin comprises at least 80% by weight of the chewable composition. In yet other embodiments, the liquid inulin comprises at least 85% by weight of the chewable composition.

The term “gelling agent”, as used herein, means a substance which forms a gel by dissolving in water as a colloid mixture forming a weakly cohesive internal structure. Gelling agents are known in the art. The gelling agent utilized in the present invention may be chosen from, but is not limited to, gelatin, gellan gum, xanthan gum, locust bean gum, guar gum, pectin, carrageenan, gum Arabic, or combinations thereof. Preferably, the gelling agent utilized in the present invention is gelatin.

In some embodiments, the gelling agent can comprise from 1% to 15% of the chewable composition. In other embodiments, the gelling agent can comprise from 2% to 12% of the chewable composition. In yet other embodiments, the gelling agent can comprise from 3% to 10% of the chewable composition. In yet other embodiments, the gelling agent can comprise from 4% to 8% of the chewable composition. In yet other embodiments, the gelling agent can comprise about 6% of the chewable composition.

In certain embodiments, the chewable composition can include a bulk sweetener or a lower glycemic carbohydrate. The bulk sweetener may be chosen from, but is not limited to, corn sweeteners, sucrose, dextrose, invert sugar, maltose, dextrin, maltodextrin, fructose, levulose, high fructose corn syrup, corn syrup solids, galactose, trehalose, isomaltulose, fructo-oligosaccharides, and combinations thereof.

The lower glycemic carbohydrate may be chosen from, but is not limited to, fructo-oligosaccharide, galactooligosaccharide, isomaltooligosaccharide, oligodextran, D-tagatose, sorbitol, mannitol, xylitol, lactitol, erythritol, maltitol, other polyols, hydrogenated starch hydrolysates, isomalt, D-psicose, 1,5 anhydro D-fructose, and combinations thereof.

The bulk sweetener and/or the lower glycemic carbohydrate may be added to the chewable compositions at varying concentrations. The addition of these components, however, may not be preferred due to the fact that they can reduce the percentage of inulin in the chew, and also may add ingredients that could be undesirable to certain consumers. For example, the addition of some bulk sweeteners may not be desirable to those who prefer a reduced calorie chew. The use of certain lower glycemic carbohydrates could result in the chew not being able to be classified as natural.

In certain preferred embodiments of the present invention, the chewable composition does not include a bulk sweetener. In other preferred embodiments, the chewable composition does not include a lower glycemic carbohydrate. In yet other highly preferred embodiments, the chewable composition does include either a bulk sweetener or a lower glycemic carbohydrate.

In some embodiments, the chewable composition can include a high potency sweetener. The high potency sweetener may be chosen from, but is not limited to, monatin, sucralose, aspartame, saccharin, acesulfame K, alitame, thaumatin, dihydrochalcones, neotame, cyclamates, mogroside, glycyrrhizin, phyllodulcin, monellin, mabinlin, brazzein, circulin, pentadin, Stevia based glycosides, and combinations thereof.

In some embodiments, the high potency sweetener can comprise from 0.01% to 1% of the chewable composition. In other embodiments, the high potency sweetener can comprise from 0.05% to 0.5% of the chewable composition. In yet other embodiments, the high potency sweetener can comprise from 0.1% to 0.5% of the chewable composition.

Unlike some bulk sweeteners and/or lower glycemic carbohydrates, high potency sweeteners can be incorporated in very small quantities to the chew to obtain the desired sweetening effect. Thus, the percentage of liquid inulin in the chew can be maintained at very high levels. Preferred high potency sweeteners are those that are natural high potency sweeteners.

In some embodiments, the chewable composition can include a flavoring. A flavoring refers to a substance which gives flavor to another substance. Flavorings are well known in the art.

The flavoring used in the present invention can be a natural or artificial flavoring, or a combination thereof. Preferably, the flavorings used in the chewable composition are natural flavorings rather than artificial flavorings.

Like the high potency sweetener, the flavoring can typically be present in very small amounts in the chew to obtain its desired effect thereby not displacing a significant amount of inulin. Additionally, a natural flavoring could provide a chewable composition that has a natural label.

In some embodiments, the chewable composition can include a coloring. A coloring refers to a substance which gives color to another substance. The coloring can provide the chewable composition with a desirable color. The coloring used in the present invention can be a natural or artificial coloring, or combinations thereof. Preferably, the colorings used in the chewable composition are natural colorings rather than artificial colorings.

Like the high potency sweetener and flavoring, the coloring can be included in the chewable composition in very small quantities.

The present disclosure also relates to methods of making the chewable compositions described herein. The method includes: (a) providing liquid inulin; (b) combining the liquid inulin with a gelling agent solution to yield a liquid inulin gelling agent mixture; (c) depositing the liquid inulin gelling agent mixture into a mould; (d) allowing the liquid inulin gelling agent mixture in the mould to set to yield a liquid inulin chewable composition; and (e) removing the liquid inulin chewable composition from the mould.

The liquid inulin can be provided at particular elevated temperatures. In some embodiments, the liquid inulin can be provided at temperatures ranging from 100° F. to 180° F. In other embodiments, the liquid inulin can be provided at temperatures ranging from 110° F. to 170° F. In yet other embodiments, the liquid inulin can be provided at temperatures ranging from 120° F. to 170° F. In yet other embodiments, the liquid inulin can be provided at temperatures ranging from 120° F. to 160° F. In yet other embodiments, the liquid inulin can be provided at temperatures ranging from 140° F. to 170° F. In yet other embodiments, the liquid inulin can be provided at temperatures ranging from 150° F. to 160° F. In yet other embodiments; the liquid inulin can be provided at temperatures ranging from 110° F. to 130° F.

In yet other embodiments, the liquid inulin can be provided at a temperature of at least 100° F. In yet other embodiments, the liquid inulin can be provided at a temperature of at least 110° F. In yet other embodiments, the liquid inulin can be provided at a temperature of at least 120° F.

Various gelling agent solutions can be utilized. The gelling agent solutions are made by combining a gelling agent with heated water. The gelling agents possible are those described herein. In some embodiments the gelling agent is gelatin. The production of a gelling agent solution is well known in the art.

When the liquid inulin is combined with the gelling agent solution, it is also possible to include other desired ingredients into the mixture as well, such as high potency sweeteners, flavorings, or colorings. Once the liquid inulin, gelling agent solution, and other ingredients are mixed, they are deposited onto a mould.

The liquid inulin gelling agent mixture must be left in the mould for a sufficient period of time to be set. To be “set” means that the chewable compositions are solid but malleable, and ready to be removed from the mould. The chewable compositions can be tested by squeezing them between the thumb and fore finger. If the chewable compositions do not expel liquid when they are squeezed, that means they are set. If, on the other hand, the chewable compositions expel liquid when squeezed, that indicates that they are not yet set.

Typical chewable compositions require four to fourteen hours to set in a mould at room temperature (about 75° F.). The liquid inulin gelling agent mixture of the present invention surprisingly requires less time to set in a mould. In some embodiments, the liquid inulin gelling agent mixture is allowed to set in the mould for less than 4 hours to yield a liquid inulin chewable composition. In other embodiments, the liquid inulin gelling agent mixture is allowed to set in the mould for less than 3 hours to yield a liquid inulin chewable composition. In yet other embodiments, the liquid inulin gelling agent mixture is allowed to set in the mould for less than 2.5 hours to yield a liquid inulin chewable composition. In yet other embodiments, the liquid inulin gelling agent mixture is allowed to set in the mould for about 2 hours to yield a liquid inulin chewable composition.

Preferred conditions for allowing the liquid inulin gelling agent mixture to set are about 75° F. and 30% relative humidity, but other conditions could also be used. Once it is set, the liquid inulin chewable composition can be removed from the mould. Once removed, the liquid inulin chewable composition can be brushed, sanded, and/or polished.

The concentrations of liquid inulin and gelling agent utilized in the process are those described herein.

### EXAMPLES

The present invention is further illustrated by the examples provided below. It is understood that these examples are not intended to limit the scope of the present invention in any way.

### Example 1

### Evaluation of Inulin Powders versus Liquid Inulin

The following types of powdered inulin were obtained from Cosucra Groupe Warcoing: Fibruline® S20 Inulin, Fibruline® DS2 Inulin, Fibruline® Instant Inulin, Fibruline® XL Inulin, and Fibrulose® F97 Inulin. The following type of liquid inulin was also obtained from Cosucra Groupe Warcoing: Fibrulose® L85 Inulin.

An evaluation was conducted where several batches of gummis (chewable compositions) were produced each utilizing one of these types of inulin. Each of these types of inulin had a differing percentage of fiber (as seen in Table 2 below). Each batch was produced (or attempted to be produced) with the same amount of dietary fiber in the gummis. Table 1 describes the ingredients by weight percentage for each batch.

TABLE 1

| Ingredients | Batch | Batch | Batch | Batch | Batch | Batch |
|---|---|---|---|---|---|---|
| (by weight percentage) | 1 | 2 | 3 | 4 | 5 | 6 |
| Gel Solution | 17 | 17 | 17 | 17 | 17 | 17 |
| Water | 27 | 28.67 | 24 | 24 | 29 | 0 |
| Fibrulose ® F97 Inulin | 56 | | | | | |
| Fibruline ® DS2 Inulin | | 54.33 | | | | |
| Fibruline ® S20 Inulin | | | 59 | | | |
| Fibruline ® Instant Inulin | | | | 59 | | |
| Fibruline ® XL Inulin | | | | | 54 | |
| Fibrulose ® L85 Inulin | | | | | | 83 |
| TOTAL | 100 | 100 | 100 | 100 | 100 | 100 |
| Water Temperature (° F.) | 174 | 164 | 160 | 165 | 175 | |

As seen in the table above, each batch included 17% by weight gel solution. Table 2 below lists the amount of percentage of fiber in each type of inulin and the corresponding percentage of fiber included in each batch of gummis.

TABLE 2

| | Dietary Fiber | Percentage | |
|---|---|---|---|
| | (by percentage | of Inulin | Percentage of |
| Type of | in the type | ingredient for | Dietary Fiber |
| Inulin | of Inulin) | each Batch | per Batch |
| Fibrulose ® | 95% | 56% (Batch 1) | 53.2% (Batch 1) |
| F97 Inulin | | | |
| Fibruline ® | 98% | 54.33% (Batch 2) | 53.2% (Batch 2) |
| DS2 Inulin | | | |
| Fibruline ® | 90% | 59% (Batch 3) | 53.1% (Batch 3) |
| S20 Inulin | | | |
| Fibruline ® | 90% | 59% (Batch 4) | 53.1% (Batch 4) |
| Instant Inulin | | | |
| Fibruline ® | 98.5% | 54% (Batch 5) | 53.2% (Batch 5) |
| XL Inulin | | | |
| Fibrulose ® | 64% | 83% (Batch 6) | 53.1% (Batch 6) |
| L85 Inulin | | | |

As seen in Table 2, each batch of gummis had approximately the same amount of dietary fiber. Since the powdered inulins had greater percentages of dietary fiber than liquid inulin, and each batch of gummis included 17% gel solution, the remaining balance of each formula was made up by water (as seen in Table 1).

The gel solution was made as follows. Gelatin bloom 225 was obtained from Gelita USA, Inc. The gel solution was made by weight with 33% gelatin and 67% water. The gelatin was weighed into a 600 mL stainless steel beaker. Hot tap water (120° F.) was poured onto the gelatin and stirred with a small metal spatula until the water and gelatin were well incorporated. The gelatin was hydrated for a minimum of 20 minutes in a hot water bath (140° F.). Enough gel solution was made for several batches of inulin gummis.

The batches of gummies made using powdered inulin were produced as follows. Each powdered inulin was first blended with the determined amount of water (as seen in Table 1) and heated in a microwave to the temperature shown in Table 1. The batches using Fibruline®. XL Inulin and Fibruline® Instant Inulin (Batch 4 and 5) immediately absorbed all of the water, were no longer pourable, and were therefore discarded. The batch using Fibrulose® F97 Inulin (Batch 1) formed a very lumpy solution in the water. The solution was pourable, but because the large lumps would not dissolve, it was discarded as well.

The batches using Fibruline® S20 Inulin and Fibruline® DS2 Inulin (Batch 2 and 3) both solubilized in the water, but still contained small lumps that would not dissolve. These were retained. The predetermined amount of gel solution was added to each mixture of powdered inulin and water. The resulting mixtures were then deposited through a funnel into starch moulds.

The batch of gummis made using liquid inulin was produced as follows. The Fibrulose® L85 liquid inulin was heated to between 160° F.-175° F., combined with the gel solution and poured through a funnel into starch moulds.

All of the gummis from each non-discarded batch (Batch 2, 3, and 6) were held in the starch moulds for 24 hours. After 24 hours, the gummis were removed from the starch moulds and their appearance and texture were assessed.

The gummis produced with liquid inulin were soft, chewy and clear in appearance. These are desirable qualities in a gummi candy. In contrast, the gummis made with 2 of the powdered inulins (Fibruline® S20 Inulin and Fibruline® DS2 Inulin) were opaque, had a surface crust, and had centers which looked like paste rather than a gummi. Very high fiber inulin gummis were not able to be made with the other types of powder inulin. Only the gummis made with liquid inulin resulted in very high fiber gummis with desirable characteristics.

It is also noted that it was possible to exclude the step of mixing inulin with water to provide it in a pourable state when using liquid inulin to produce these high fiber gummis. This could advantageously provide increased processing efficiency, particularly when used in a commercial scale.

### Example 2

### Production of Gummis with Liquid Inulin

Gel solution was produced in the same manner as in Example 1. The following type of liquid inulin was obtained from Cosucra Groupe Warcoing: Fibrulose® L85 Inulin. Citric acid, anhydrous, was obtained from Cargill, Incorporated. Exberry® Food Coloring (orange, yellow, and purple) was obtained from GNT Group. Carnauba wax was obtained from Colorcon, Inc.

The list of ingredients and proportions by weigh percent are listed in Table 3 below, and the process is described thereafter.

TABLE 3

| Ingredients (by weight | Orange | Yellow | Purple |
|---|---|---|---|
| percent) | Gummis | Gummis | Gummis |
| Gel Solution | 17 | 17 | 17 |
| Fibrulose ® L85 Inulin | 82.6 | 82.4 | 82.9 |
| (Liquid Inulin) | | | |
| Citric Acid | 0.3 | 0.5 | — |
| Color | 0.1 | 0.1 | 0.1 |
| TOTAL | 100 | 100 | 100 |
| Liquid Inulin Syrup | 156 | 151 | 158 |
| Temperature (° F.) just | | | |
| prior to addition of | | | |
| Gel Solution | | | |

The liquid inulin was poured into a beaker. The beaker was placed into a microwave and heated for two 30 second increments. After the first 30 seconds, the temperature of each of the liquid inulin syrups ranged between 120° F. and 122° F. After the second 30 second increment, the temperature ranged between 150° F. and 158° F. (as shown in table 3).

Each liquid inulin syrup was stirred with a heatproof spatula after each heating. After the second heating the gel solution, color, and acid (if acid was used) were added, and stirred until all ingredients were well incorporated. Each solution was poured into a funnel and deposited onto starch molds immediately. The gummies were then held in the starch moulds in a controlled environment (75° F. and 30% relative humidity).

After one hour, one of each colored gummi was removed from the starch mould to test to determine if setting was complete. All three samples were still slightly wet in the center. Another of each color gummi was tested after 90 minutes. They were still not set. After two hours, one of each was again tested. They were now set.

All of the gummis were removed from the starch moulds, and excess starch was removed with a pastry brush. The gummis were then polished with carnauba wax. The batch of gummis (orange, yellow, purple) were placed in separate Whirly Pak® bags. The air was compressed out of the bags and they were twist tied. They were stored in a room where temperature ranged from 62° F. to 85° F.

It was unexpected that the gummis would set within only 2 hours. Typical commercial gummis take 4 to 14 hours to set. The reduction in processing time could be a significant commercial benefit. Being able to remove the samples from the moulds after only two hours of setting time allows manufacturers to produce more than what they currently are able to produce in the same timeframe. The potential to improve production efficiency is substantial.

### Example 3

### Production of Gummis with Liquid Inulin at Reduced Temperatures

Gummis were produced using liquid inulin in the same manner as described in example 2, and with the same relative amounts of ingredients as listed in table 3 above for the purple gummies. In this example, however, the liquid inulin was provided at a lower temperature prior to addition to the gel solution. In one trial the liquid inulin was used at ambient temperatures (approximately 73° F.). In a second trial, the liquid inulin was heated to 120° F. prior to addition of the gel solution.

When liquid inulin was provided at ambient temperatures (73° F.), production of the gummis did not prove successful. When the gel solution (held at approximately 120° F.) contacted the liquid inulin (at 73° F.), the entire mass gelled too rapidly to be able to stir and pour into moulds.

When the liquid inulin was heated to 120° F. prior to addition of the gel solution, the gummis were successfully produced having soft and chewy texture and were clear in appearance—characteristics desirable in a chewable composition.

We claim:

1. A chewable composition comprising liquid inulin, a gelling agent, and water, wherein liquid inulin comprises at least 60% by weight of the chewable composition.

2. The chewable composition of claim 1, wherein liquid inulin comprises at least 65% by weight of the chewable composition.

3. The chewable composition of claim 1, wherein liquid inulin comprises at least 75% by weight of the chewable composition.

4. The chewable composition of claim 1, wherein liquid inulin comprises at least 80% by weight of the chewable composition.

5. The chewable composition of claim 1, wherein the gelling agent comprises from 2% to 12% of the chewable composition.

6. The chewable composition of claim 1, wherein the gelling agent is gelatin.

7. The chewable composition of claim 1, further comprising a high potency sweetener.

8. The chewable composition of claim 7, wherein the high potency sweetener is a natural high potency sweetener.

9. The chewable composition of claim 1, further comprising a flavoring.

10. The chewable composition of claim 1, further comprising a coloring.

11. The chewable composition of claim 1, wherein the chewable composition does not include a bulk sweetener or a lower glycemic carbohydrate.

12. A method of producing a chewable composition comprising:
(a) providing liquid inulin;
(b) combining the liquid inulin with a gelling agent solution to yield a liquid inulin gelling agent mixture;
(c) depositing the liquid inulin gelling agent mixture into a mould;
(d) allowing the liquid inulin gelling agent mixture in the mould to set to yield a liquid inulin chewable composition; and
(e) removing the liquid inulin chewable composition from the mould.

13. The method according to claim 12, wherein the liquid inulin is provided at a temperature ranging from about 100° F. to about 180° F.

14. The method according to claim 12, wherein the liquid inulin is provided at a temperature ranging from about 120° F. to about 160° F.

15. The method according to claim 12, wherein the liquid inulin is provided at a temperature ranging from about 110° F. to about 130° F.

16. The method according to claim 12, wherein the liquid inulin gelling agent mixture is allowed to set in the mould for less than 4 hours to yield a liquid inulin chewable composition.

17. The method according to claim 12, wherein the liquid inulin gelling agent mixture is allowed to set in the mould for less than 2.5 hours to yield a liquid inulin chewable composition.
